(19) United States
(12) Patent Application Publication
(10) Pub. No.: US 2019/0181704 A1
(43) Pub. Date: Jun. 13, 2019

(54) BRUSHLESS DC ELECTRIC MOTOR FOR AUTOMOTIVE VEHICLE WIPER SYSTEM

(71) Applicant: Valeo Systèmes d'Essuyage, Le Mesnil Saint Denis (FR)

(72) Inventor: Jose Luis Herrada, La Verriere (FR)

(73) Assignee: Valeo Systèmes d'Essuyage, Le Mesnil Saint Denis (FR)

(21) Appl. No.: 16/207,877

(22) Filed: Dec. 3, 2018

(30) Foreign Application Priority Data
Dec. 8, 2017 (FR) 1761818

(51) Int. Cl. H02K 1/27; H02K 21/16; B60S 1/08; H02K 1/14

(52) U.S. Cl. CPC H02K 1/278; H02K 1/14; B60S 1/08; H02K 21/16

(57) ABSTRACT

The invention relates to a dc electric motor, in particular of the brushless type, for a motor vehicle wiper system, comprising a stator (2) and a rotor (3), the stator (2) comprising a plurality of coils (4) for electromagnetic excitation of the rotor (3) and the rotor (3) comprising a multi-pole magnet (5) mounted so as to perform a rotational movement about an axis of rotation (L) and provided with at least two pairs of opposite poles, wherein at least three poles each have a width in a plane (P) orthogonal to the axis of rotation (L) which is different from that of the said at least two other poles, and/or three poles with the same polarity are angularly shifted.

The invention relates to a dc electric motor, preferably of the brushless type, for a motor vehicle wiper system.

It is known that such an electric motor comprises mainly a rotor and a stator.

Generally, the stator comprises a plurality of coils for electromagnetic excitation of the rotor while the rotor comprises a multi-pole magnet.

The electric motor is configured so that, when the coils are supplied with electric current, a magnetic field is created, producing a rotational movement of the multi-pole magnet about an axis of rotation.

In a known manner, the electric motor is designed to operate with sinusoidal coil supply voltages, this requiring the generation of a back electromotive force having a sinusoidal form.

It is difficult to generate the appropriate sinusoidal form, in particular owing to the concentration of coils.

The object of the invention is to improve this situation.

For this purpose, the invention relates to a dc electric motor, in particular of the brushless type, for a motor vehicle wiper system, comprising a stator and a rotor, the stator comprising a plurality of coils for electromagnetic excitation of the rotor and the rotor comprising a multi-pole magnet mounted so as to perform a rotational movement about an axis of rotation and provided with at least two pairs of opposite poles, wherein at least three poles each have a width in a plane orthogonal to the axis of rotation which is different from that of the said at least two other poles, and/or three poles with the same polarity are angularly shifted.

Thus, the electromagnetic force generated assumes a form which is close to the ideal curve, despite the concentrated coils.

According to another characteristic feature of the invention, the motor comprises three pairs of opposite poles.

According to another characteristic feature of the invention, each pole is configured so that the multi-pole magnet is contained in a cylinder, an axis of symmetry of which coincides with the axis of rotation, and each pole defines an angular sector in a plane orthogonal to the axis of rotation, at least three angular sectors being different from each other.

According to another characteristic feature of the invention, the two opposite poles of each pair are arranged opposite each other, being positioned in a diametrically opposite manner in a plane orthogonal to the axis of rotation.

According to another characteristic feature of the invention, the two opposite poles of each pair have the same width in a plane orthogonal to the axis of rotation.

According to another characteristic feature of the invention, the motor comprises three pairs of opposite poles and the two opposite poles of each pair define an angular sector in a plane orthogonal to the axis of rotation with a same angle value.

According to another characteristic feature of the invention, the angular sector of a first pair has an angle of between 30° and 39°, the angular sector of a second pair has an angle of between 40° and 49°, and the angular sector of a third pair has an angle of between 50° et 59°.

The invention also relates to a motor vehicle wiper system, comprising an electric motor as described above.

Further characteristic features and advantages of the invention will become clear from a reading of the description which is provided below.

This description is purely illustrative and must be read with reference to the attached drawings in which:

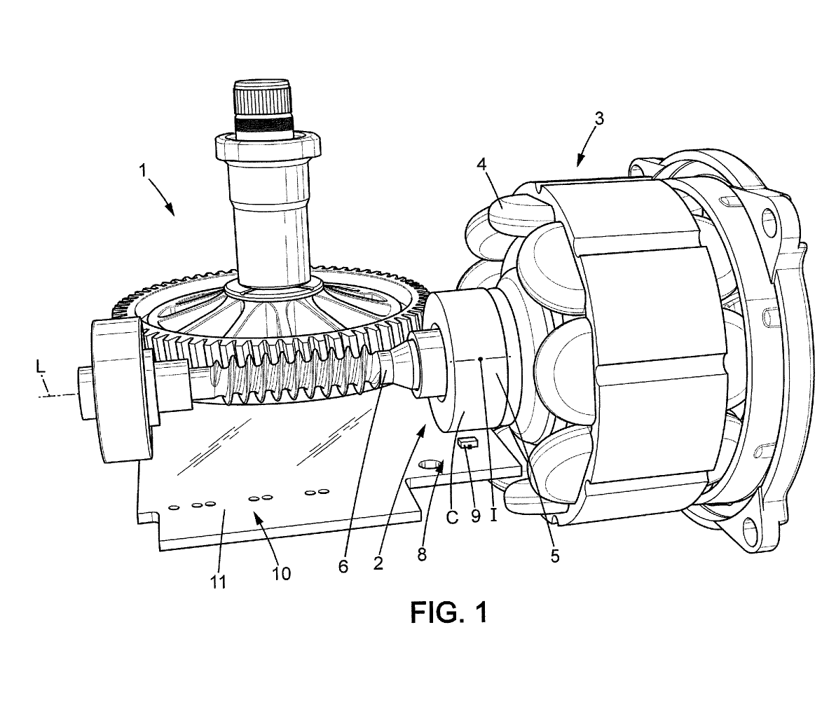

FIG. 1 shows a perspective view of an electric motor according to the present invention;

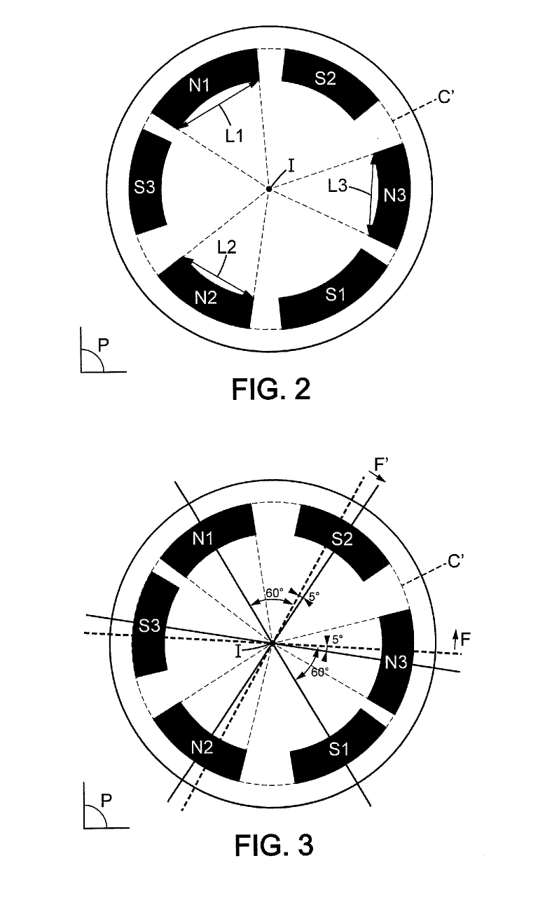

FIG. 2 shows a cross-section through a rotor shown in FIG. 1 according to a first embodiment of the invention; and

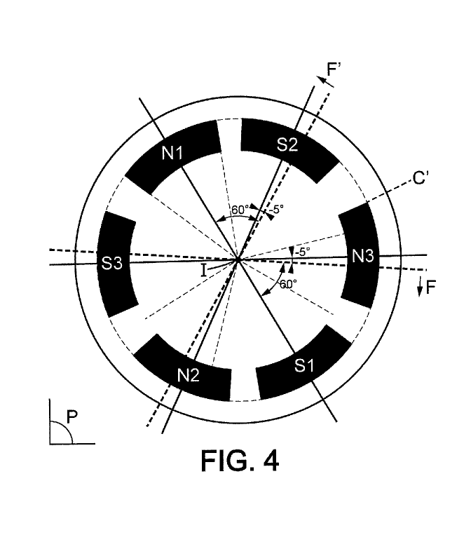

FIGS. 3 and 4 shows a cross-section through a rotor shown in FIG. 1 according to a second embodiment of the invention.

### ELECTRIC MOTOR

The invention relates to a dc electric motor, preferably of the brushless type, for a motor vehicle wiper system, indicated by the reference 1 in FIG. 1.

As can be seen in FIG. 1, the electric motor 1 comprises a rotor 2 and a stator 3.

The stator 3 comprises a plurality of coils 4 for electromagnetic excitation of the rotor 2.

The rotor 2 comprises a multi-pole magnet 5 mounted so as to perform a rotational movement about an axis of rotation, indicated by the reference L.

The electric motor 1 is configured so that the rotor 2 rotates inside the stator 3, this producing a rotation of a drive shaft 6 integral with the multi-pole magnet 5.

The drive shaft 6 extends along the axis of rotation L.

The multi-pole magnet 5 is provided with at least two pairs of opposite poles 7.

A rotor position sensor, for example a Hall effect sensor 9, allows the power supply of the coils of the stator 3 to be switched.

In the embodiments shown, the multi-pole magnet 5 comprises three pairs of opposite North-South poles, indicated by the references N1, S1, N2, S2 and N3, S3, respectively.

Each pole is for example a bar of magnetic material.

Each bar is preferably chamfered, as will be described in further detail.

The poles define a cylinder of revolution C, an axis of symmetry of which coincides with the axis of rotation L.

Thus, as can be seen in FIGS. 2 and 3, the poles N1 to S3 define a circle C′ in a plane P orthogonal to the axis of rotation L.

The invention will now be described with reference to the embodiment of FIG. 2.

According to this embodiment, at least three poles each have a width in the plane P orthogonal to the axis of rotation which is different from that of the said at least two other poles.

The orthogonal plane P passes advantageously through the centre of the cylinder of revolution C.

“Width” is understood as meaning a dimension at a given distance from the centre I of the circle C′.

As already indicated, owing to different widths, the electromotive force generated is a sinusoid which is smoother than in the prior art.

Another advantage is that there is no simultaneous coincidence of these edges with the stator slots which generate noise.

In the embodiment shown in FIG. 2, the opposite poles of a same pair have the same width, denoted L1 for the first pair, L2 for the second pair, and L3 for the third pair.

As can be seen from FIG. 2, the widths L1, L2 and L3 are different from each other.

As can also be seen in FIG. 2, the poles of a same pair extend opposite each other and are positioned diametrically opposite in the plane P.

It can also be noted that the three magnets with the same polarity are centred on a 120° reference point.

As already mentioned, each pole is a chamfered bar.

Thus, in the plane P, each pole defines an angular sector, denoted A-N1, A-S1, A-N2, A-S2, A-N3 and A-S3.

Preferably, at least three angular sectors are different from each other.

Advantageously, the angular sectors of the opposite poles of a same pair are identical.

In this case, the angular sector defined by each of the poles N1, S1, called first angular sector, has an angle of between 30° and 39°, the angular sector defined by each of the poles N2, S2, called second angular sector, has an angle of between 40° and 49°, and the angular sector defined by each of the poles N3, S3, called third angular sector, has an angle of between 50° and 59°.

Preferably, the first angular sector has an angle of about 38°, the second angular sector has an angle of about 48° and the third angular sector has an angle of about 58°.

According to another embodiment, shown in FIGS. 3 and 4, the three sides of the magnets with the same polarity are not all arranged at 120° but are angularly shifted.

In this case, the magnet have preferably identical widths.

In FIG. 3, if the magnets N1 and S1 are taken as the reference point, the pair of magnets N2, S2 is shifted by 5° in the direction of the arrow F′ (in the case of S2) and the pair N3, S3 is shifted by 5° in the direction of the arrow F (in the case of N3).

In FIG. 4, if the magnets N1 and S1 are taken as the reference point, the pair of magnets N2, S2 is shifted by 5° in the direction of the arrow F′ (in the case of S2) and the pair N3, S3 is shifted by 5° in the direction of the arrow F (in the case of N3).

The angular shift ensures that there is no simultaneous coincidence of these edges with the stator slots which generate noise.

It should be noted that the two embodiments described may be combined.

For example, each pole N1, S1 may have a width of 50°, and each pole N2, S2 and N3, S3 may have a width of 40°, being angularly shifted by 15°.

1. A dc electric motor of a brushless type, for a motor vehicle wiper system, comprising:
a stator; and
a rotor (3),
the stator comprising a plurality of coils for electromagnetic excitation of the rotor, and
the rotor comprising a multi-pole magnet mounted to perform a rotational movement about an axis of rotation and provided with at least two pairs of opposite poles,
wherein at least three poles each have a width in a plane orthogonal to the axis of rotation which is different from that of the said at least two other poles, and/or three poles with the same polarity are angularly shifted.

2. The electric motor according to claim 1, comprising three pairs of opposite poles.

3. The electric motor according to claim 1, wherein each pole is configured so that the multi-pole magnet is contained in a cylinder, an axis of symmetry of which coincides with the axis of rotation, and each pole defines an angular sector in a plane orthogonal to the axis of rotation, at least three angular sectors being different from each other.

4. The electric motor according to claim 1, wherein the two opposite poles of each pair are arranged opposite each other, being positioned in a diametrically opposite manner in a plane orthogonal to the axis of rotation.

5. The electric motor according to claim 1, wherein the two opposite poles of each pair have the same width in a plane orthogonal to the axis of rotation.

6. The electric motor according to claim 1, comprising three pairs of opposite poles, wherein the two opposite poles of each pair define an angular sector in a plane orthogonal to the axis of rotation having a same angle value.

7. The electric motor according to claim 6, wherein the angular sector of a first pair has an angle of between 30° and 39°, the angular sector of a second pair has an angle of between 40° and 49°, and the angular sector of a third pair has an angle of between 50° and 59°.

8. A motor vehicle wiper system, comprising an electric motor according to claim 1.
